(19) United States
(12) Patent Application Publication
(10) Pub. No.: US 2021/0233412 A1
(43) Pub. Date: Jul. 29, 2021

(54) SYSTEMS AND METHODS FOR REDUCING CONTROLLER-PILOT REJECTION RATIOS

(71) Applicant: HONEYWELL INTERNATIONAL INC., Charlotte, NC (US)

(72) Inventors: Suresh Bazawada, Bangalore (IN); Anil Kumar Songa, Bangalore (IN); Jonathan Davis, Phoenix, AZ (US); Sadguni Venkataswamy, Bangalore (IN)

(73) Assignee: HONEYWELL INTERNATIONAL INC., Charlotte, NC (US)

(21) Appl. No.: 17/099,911

(22) Filed: Nov. 17, 2020

(30) Foreign Application Priority Data
Jan. 23, 2020 (IN) 202011003065

(51) Int. Cl. G08G 5/00

(52) U.S. Cl. CPC G08G 5/0021; G08G 5/0047; G08G 5/0078; G08G 5/0013

(57) ABSTRACT

Provided are technologically improved systems and methods for reducing controller-pilot data link (CPDLC) rejection ratio on an aircraft. The system is programmed to receive a user provided tentative CPDLC request. The system receives traffic data from an external traffic data source and data from a navigation system and a sensor system. The system predicts whether the tentative CPDLC request will be accepted by air traffic control (ATC), based on the received data. The system further predicts a potential delay time until the ATC will accept the tentative CPDLC request. The system additionally provides one or more alternative CPDLC requests and their potential delay times when the system has predicted that the tentative CPDLC request will be rejected. The system displays this information and receives user selections based thereon. Upon receiving a user selection, a CPDLC request is sent to ATC in accordance with a predicted delay time.

### CROSS REFERENCE TO RELATED APPLICATION

This application claims priority to Indian Provisional Patent Application No. 202011003065, filed Jan. 23, 2020, the entire content of which is incorporated by reference herein.

### TECHNICAL FIELD

The technical field generally relates to communications between aircraft and air traffic control (ATC), and more particularly relates to systems and methods for reducing controller-pilot rejection ratios.

### BACKGROUND

Controller-pilot data link communication (CPDLC) is a means of communication between a controller at ATC and a pilot of an aircraft, generally using a data link for the communication. CPDLC systems include a set of predefined clearance/information/request message elements that correspond to voice phraseology employed during ATC procedures. The controller is provided with the capability to issue to the pilot level assignments, crossing constraints, lateral deviations, route changes and clearances, speed assignments, radio frequency assignments, and various requests for information. The pilot is provided with the capability to respond to the ATC messages, ATC request clearances and information, to report to ATC information, including declaring/rescinding an emergency. The pilot is, in addition, provided with the capability to request conditional clearances (downstream) and information from a downstream air traffic service unit (ATSU). A CPDLC system ‘dialogue’ includes a sequence of messages between the controller and a pilot relating to a particular transaction (for example a request for clearance and a receipt of a clearance grant). Moreover, one dialogue can include several sequences of messages, each of which is closed by means of appropriate messages, usually of acknowledgement or acceptance. Therefore, available CPDLC systems are burdened with the technical problem of requiring the continued involvement of a human at each end of the communication; from the pilot's perspective this can be very time-consuming and inefficient.

Accordingly, improved CPDLC systems and methods that reduce the amount of pilot involvement are desirable. It is desirable to make them adaptable, responsive to real-time environmental information and available cockpit data. The following disclosure provides these technological enhancements, in addition to addressing related issues.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

Provided is a processor implemented method for reducing controller-pilot data link (CPDLC) rejection ratio on an aircraft, comprising: receiving, from a navigation system onboard the aircraft, navigation data for the aircraft; receiving sensor data from a sensor system; receiving traffic data from an external traffic data source; displaying a CPDLC window on a display system; receiving a tentative CPDLC request; processing the navigation data, traffic data, and tentative CPDLC request with airport features data to predict whether the tentative CPDLC request will be accepted; and displaying a dialogue box based upon the prediction, wherein the displayed dialogue box indicates: acceptance upon predicting that the tentative CPDLC request will be accepted; or rejected and an alternative CPDLC request upon predicting that the tentative CPDLC request will not be accepted.

Also provided is a system for reducing controller-pilot data link (CPDLC) rejection ratio on an aircraft, comprising: a navigation system providing navigation data for the aircraft; a sensor system onboard the aircraft; and a processor operationally coupled to the navigation system and sensor system and configured to: display a CPDLC window on a display system; receive a tentative CPDLC request; receive traffic data from an external traffic data source; process the navigation data, traffic data, and tentative CPDLC request with airport features data to predict whether the tentative CPDLC request will be accepted by air traffic control (ATC), and that air traffic control (ATC) will accept the tentative CPDLC request in a first amount of time; and upon predicting that the tentative CPDLC request will be accepted, display a dialogue box indicating acceptance; and display the first amount of time.

An embodiment of an aircraft is also provided. The aircraft includes: a navigation system providing navigation data for the aircraft; a sensor system onboard the aircraft; and a processor of a system for reducing controller-pilot data link (CPDLC) rejection ratio, the processor operationally coupled to the navigation system and sensor system and configured to: display a CPDLC window on a display system; receive a tentative CPDLC request; receive traffic data from an external traffic data source; process the navigation data, traffic data, and tentative CPDLC request with airport features data to predict whether the tentative CPDLC request will be accepted by air traffic control (ATC); and display a dialogue box based upon the prediction, wherein the displayed dialogue box indicates: accepted and a first amount of time upon predicting that the tentative CPDLC request will be accepted by ATC in the first amount of time; or rejected, an alternative CPDLC request, and a second amount of time upon predicting that the tentative CPDLC request will not be accepted, but the alternative CPDLC request will be accepted in the second amount of time.

Furthermore, other desirable features and characteristics of the system and method will become apparent from the subsequent detailed description and the appended claims, taken in conjunction with the accompanying drawings and the preceding background.

### BRIEF DESCRIPTION OF THE DRAWINGS

The present application will hereinafter be described in conjunction with the following drawing figures, wherein like numerals denote like elements, and:

FIG. 1 is a block diagram of a system for reducing CPDLC rejection ratios on an aircraft, in accordance with an exemplary embodiment;

FIGS. 2-8 are exemplary dialogue windows generated by the system for reducing CPDLC rejection ratios on an aircraft, in accordance with an exemplary embodiment; and

FIG. 9 is a flow diagram of a method for reducing CPDLC rejection ratios on an aircraft, in accordance with an exemplary embodiment.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Thus, any embodiment described herein as “exemplary” is not necessarily to be construed as preferred or advantageous over other embodiments. The embodiments described herein are exemplary embodiments provided to enable persons skilled in the art to make or use the invention and not to limit the scope of the invention that is defined by the claims. Furthermore, there is no intention to be bound by any expressed or implied theory presented in the preceding technical field, background, summary, or the following detailed description.

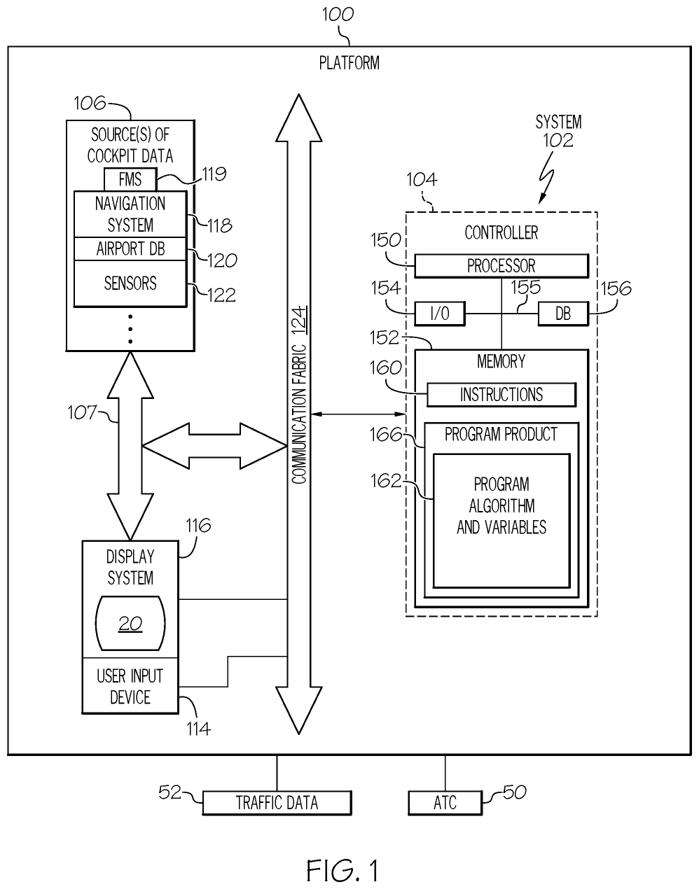

CPDLC systems generally generate a CPDLC display window on an on-board display system (FIG. 1, 116). CPDLC systems generally render, within that CPDLC display window, predefined CPDLC messages. The pilot utilizes the information displayed on the CPDLC display window to communicate with ATC, to make a request for a clearance, and to perform a variety of other communications based on the predefined CPDLC messages. Some non-limiting examples of predefined CPDLC messages for a pilot to use include:

Departure Clearance Action Message Box

Departure Clearance Uplink Example

Pre-Departure Clearance (PDC) Pop-up

CDR Pop-up

CDR Request Downlink Pop-up

Pushback Clearance Request Pop-up

Pushback/Taxi Pop-up

Taxi Clearance Request Downlink Pop-up

Oceanic Clearance Pop-up

Oceanic Clearance Request Pop-upc

As mentioned, one CPDLC system dialogue can include several sequences of messages, each sequence being closed by means of appropriate messages, usually of acknowledgement or acceptance. This presents a technical problem in that available CPDLC systems require the continued engagement of a human at each end of the communication. From a pilot's perspective, this continued engagement can be time-consuming and inefficient. Additionally, using the available CPDLC systems, the pilot can only choose the predefined CPDLC messages without being able to consider, or be informed by, the current conditions that the controller at ATC may be considering to approve/reject the request. This can increase a likelihood of a CPDLC rejection. Reacting to a CPDLC rejection from ATC introduces a time delay. The turnaround time for the pilot analyzing the rejection of the CPDLC request, particularly in single-pilot cockpit scenarios, can lead to transmitting further invalid CPDLC requests to ATC and unnecessary time delay for the pilot. Any of the above technical problems can cause an elevated rejection ratio of CPDLC requests. The proposed system for reducing CPDLC rejection ratios (FIG. 1, system 102) provides a technical solution to at least these technical problems. The figures and descriptions below provide more detail.

Turning now to FIG. 1, in an embodiment, the system for reducing CPDLC rejection ratios 102 (also referred to herein as “system” 102) is generally associated with a mobile platform 100. In various embodiments, the mobile platform 100 is an aircraft, and is referred to as aircraft 100. Exemplary embodiments of the system 102 provide a technical solution to the above-mentioned technical problems in the form of a controller 104 (which may also be referred to herein as a control module) embodying a processor 150 programmed with novel rules and parameters (program 162).

In operation, the controller 104 may be operationally coupled to any combination of the following systems and apparatus: one or more sources 106 of cockpit data 107 (including an inertial navigation system/navigation system 118; a flight management system (FMS) 119; an airport features database 120; and a sensor system 122); a communication system and fabric 124; a display system 116; and a user input device 114. In various embodiments, the controller 104 is also operationally coupled to external sources, such as air traffic control (ATC) 50 and external traffic, referred to as traffic data sources 52, each of which communicate wirelessly with the controller 104. These functional blocks are described in more detail below.

In some embodiments, the controller 104 may be integrated within a preexisting mobile platform management system, avionics system, cockpit display system (CDS), flight controls system (FCS), or flight management system (FMS). Although the controller 104 is shown as an independent functional block, onboard the aircraft 100, in other embodiments, it may exist in an electronic flight bag (EFB) or portable electronic device (PED), such as a tablet, cellular phone, or the like. In embodiments in which the controller is within an EFB or a PED, a display system 116 and a user input device 114 may also be part of the EFB or PED.

The inertial navigation system 118 provides real-time aircraft state data. Real-time aircraft state data may include any of: an instantaneous location (e.g., the latitude, longitude, orientation), an instantaneous heading (i.e., the direction the aircraft is traveling in relative to some reference), a flight path angle, a vertical speed, a ground speed, an instantaneous altitude (or height above ground level), and a current phase of flight of the aircraft 100. As used herein, “real-time” is interchangeable with current and instantaneous. The inertial navigation system 118 may be realized as including a global positioning system (GPS), inertial reference system (IRS) or AHRS, or a radio-based navigation system (e.g., VHF omni-directional radio range (VOR) or long-range aid to navigation (LORAN)), and may include one or more navigational radios, barometers, or other sensors suitably configured to support operation of a flight management system (FMS), as will be appreciated in the art. In various embodiments, the data referred to herein as the real-time aircraft state data may be referred to as navigation data. The real-time aircraft state data is made available, generally by way of the communication system and fabric 124, so other components, such as the controller 104 and the display system 116, may further process and/or handle the aircraft state data.

In various embodiments, the communications system and fabric 124 is configured to support instantaneous (i.e., real-time or current) communications between on-board systems, the controller 104, external traffic data sources 52, and ATC 50. As a functional block, the communications system and fabric 124 may represent one or more transmitters, receivers, and the supporting communications hardware and software required for components of the system 102 to communicate as described herein. In various embodiments, the communications system and fabric 124 has bidirectional pilot-to-ATC (air traffic control) communications via a datalink, and any other suitable radio communication system that supports communications between the aircraft 100 and various external source(s).

The user input device 114 and the controller 104 are cooperatively configured to allow a user (e.g., a pilot, co-pilot, or crew member) to interact with display devices in the display system 116 and/or other elements of the system 102, as described herein. Depending on the embodiment, the user input device 114 may be realized as a cursor control device (CCD), keypad, touchpad, keyboard, mouse, touch panel (or touchscreen), joystick, knob, line select key, voice controller, gesture controller, or another suitable device adapted to receive input from a user. When the user input device 114 is configured as a touchpad or touchscreen, it may be integrated with the display system 116. As used herein, the user input device 114 may be used by a pilot to communicate with external sources, to modify or upload the program product 166, etc. In various embodiments, the display system 116 and user input device 114 are onboard the aircraft 100 and are also operationally coupled to the communication system and fabric 124. In some embodiments, the controller 104, user input device 114, and display system 116 are configured as a control display unit (CDU).

The controller 104 may perform display processing. As such, the controller 104 generates display commands for the display system 116 to cause the display device 20 to render thereon the various graphical user interface elements, tables, icons, alerts, menus, buttons, and pictorial images, as described herein. The display system 116 is configured to continuously receive and process the display commands from the controller 104, and, based thereon, to display information in various forms, such as an airport moving map (AMM). The display system 116 includes a display device 20. In various embodiments described herein, the display system 116 includes a synthetic vision system (SVS). In exemplary embodiments, the display device 20 is realized on one or more electronic display devices, such as a multi-function display (MFD) or a multi-function control display unit (MCDU), configured as any combination of: a head up display (HUD), an alphanumeric display, a vertical situation display (VSD) and a lateral navigation display (ND).

The controller 104 may perform graphical processing. Responsive to display commands, renderings on the display system 116 may be processed by a graphics system, components of which may be integrated into the display system 116 and/or be integrated within the controller 104. Display methods include various types of computer-generated symbols, text, and graphic information representing, for example, pitch, heading, flight path, airspeed, altitude, runway information, waypoints, targets, obstacles, terrain, and required navigation performance (RNP) data in an integrated, multi-color or monochrome form. Display methods also include various formatting techniques for visually distinguishing objects and routes from among other similar objects and routes. The controller 104 may be said to display various images and selectable options described herein. In practice, this may mean that the controller 104 generates display commands, and, responsive to receiving the display commands from the controller 104, the display system 116 displays, renders, or otherwise visually conveys on the display device 20, various graphical images associated with operation of the aircraft 100.

Cockpit data 107 generally represents onboard data that is available to the pilot or crew in the cockpit of the aircraft. For example, sources of cockpit data may include the navigation system 118, an airport features database 120, a flight management system (FMS) 119, and sensor system 122. In various embodiments, cockpit data 107 is communicated to the pilot and crew via graphical displays on the display system 116. In practice, there are a multitude of cockpit data 107 providing a respective multitude of information and sourced by a multitude of onboard aircraft systems. A variety of types of sensors in sensor system 122 detect various aspects of aircraft performance and aircraft conditions, in addition to sensing external operating conditions, such as weather and other aircraft and objects. Sensor data is output from the sensor system 122 and made available on the communication fabric 124. The airport features database 120 stores airport maps with features such as runways, taxiways, and gates.

The controller 104 performs the functions of the system 102. As used herein, the term “controller” may be interchanged with the term “module;” each refers to any means for facilitating communications and/or interaction between the elements of the system 102 and performing additional processes, tasks and/or functions to support operation of the system 102, as described herein. In various embodiments, the controller 104 may be any hardware, software, firmware, electronic control component, processing logic, and/or processor device, individually or in any combination. Depending on the embodiment, the controller 104 may be implemented or realized with a general purpose processor (shared, dedicated, or group) controller, microprocessor, or microcontroller, and memory that executes one or more software or firmware programs; a content addressable memory; a digital signal processor; an application specific integrated circuit (ASIC), a field programmable gate array (FPGA); any suitable programmable logic device; combinational logic circuit including discrete gates or transistor logic; discrete hardware components and memory devices; and/or any combination thereof, designed to perform the functions described herein.

Accordingly, in FIG. 1, an embodiment of the controller 104 is depicted as a computer system comprising a processor 150 and a memory 152. The processor 150 may comprise any type of processor or multiple processors, single integrated circuits such as a microprocessor, or any suitable number of integrated circuit devices and/or circuit boards working in cooperation to carry out the described operations, tasks, and functions by manipulating electrical signals representing data bits at memory locations in the system memory, as well as other processing of signals. The memory 152 may comprise RAM memory, ROM memory, flash memory, registers, a hard disk, or another suitable non-transitory short or long-term storage media capable of storing computer-executable programming instructions or other data for execution. The memory 152 may be located on and/or co-located on the same computer chip as the processor 150. Generally, the memory 152 maintains data bits and may be utilized by the processor 150 as storage and/or a scratch pad during operation. Specifically, the memory 152 stores instructions and applications 160. Information in the memory 152 may be organized and/or imported from an external source during an initialization step of a process; it may also be programmed via a user input device 114. During operation, the processor 150 loads and executes one or more programs, algorithms and rules embodied as instructions and applications 160 contained within the memory 152 and, as such, controls the general operation of the controller 104 as well as the system 102.

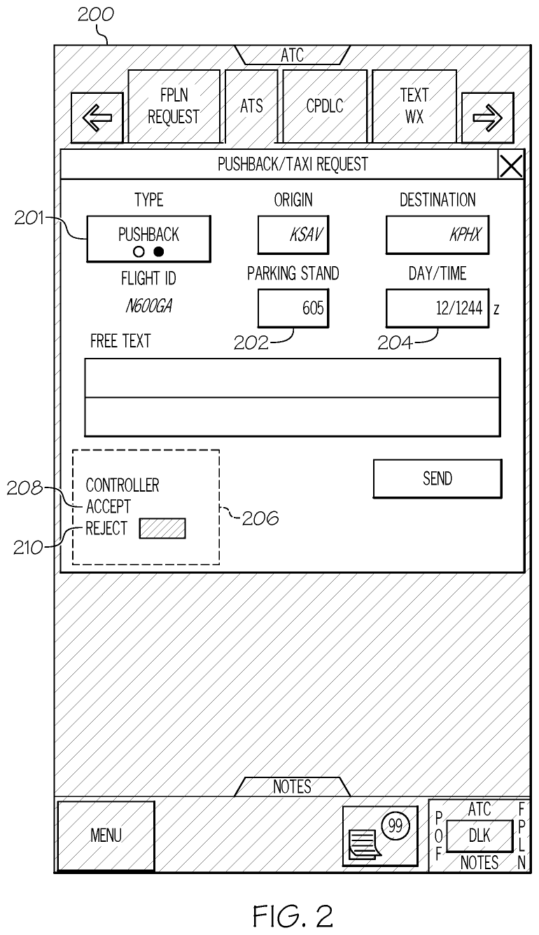

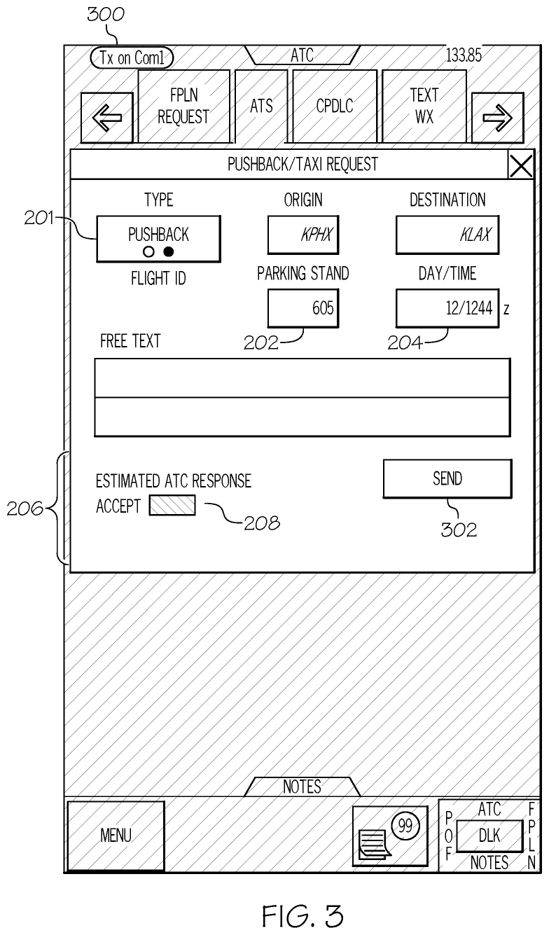

The rejection ratio reducing program (shortened to “program” 162), includes rules and instructions which, when executed by the processor 150, convert the processor 150/memory 152 configuration into the controller 104 that performs the functions, techniques, and processing tasks associated with the operation of the system 102. The program 162 specifically directs the processing of the cockpit data 107 and traffic data to predict whether a tentative CPDLC request will be accepted and causes a dialogue box to be displayed to prompt a user selection based on the prediction (displayed dialogue boxes and related functionality are described in connection with FIGS. 2-3). Novel program 162 and associated stored variables may be stored in a functional form on computer readable media, for example, as depicted, in memory 152. While the depicted exemplary embodiment of the controller 104 is described in the context of a fully functioning computer system, those skilled in the art will recognize that the mechanisms of the present disclosure are capable of being distributed as a program product 166.

As a program product 166, one or more types of non-transitory computer-readable signal bearing media may be used to store and distribute the program 162, such as a non-transitory computer readable medium bearing the program 162 and containing therein additional computer instructions for causing a computer processor (such as the processor 150) to load and execute the program 162. Such a program product 166 may take a variety of forms, and the present disclosure applies equally regardless of the type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized as memory 152 and as program product time-based viewing of clearance requests in certain embodiments.

In various embodiments, the processor/memory unit of the controller 104 may be communicatively coupled (via a bus 155) to an input/output (I/O) interface 154, and a database 156. The bus 155 serves to transmit programs, data, status and other information or signals between the various components of the controller 104. The bus 155 can be any suitable physical or logical means of connecting computer systems and components. This includes, but is not limited to, direct hard-wired connections, fiber optics, infrared and wireless bus technologies.

The I/O interface 154 enables intra controller 104 communication, as well as communications between the controller 104 and other system 102 components, and between the controller 104 and the external data sources via the communication system and fabric 124. The I/O interface 154 may include one or more network interfaces and can be implemented using any suitable method and apparatus. In various embodiments, the I/O interface 154 is configured to support communication from an external system driver and/or another computer system. In one embodiment, the I/O interface 154 is integrated with the communication system and fabric 124 and obtains data from external data source(s) directly. Also, in various embodiments, the I/O interface 154 may support communication with technicians, and/or one or more storage interfaces for direct connection to storage apparatuses, such as the database 156.

In some embodiments, the database 156 is part of the memory 152. In various embodiments, the database 156 is integrated, either within the controller 104 or external to it.

Embodiments of the system 102 for reducing CPDLC rejection ratios on an aircraft generate an enhanced CPLDC window for pilot interaction. Responsive to viewing the displayed enhanced CPDLC window, a pilot or crew makes a CPDLC request; this may be made via a touch screen input or other user input device. Moving now to FIGS. 2-4, a CPDLC pushback/taxi 201 request is depicted. Initially, the pilot makes the CPDLC request; this initial CPDLC request is a tentative request, until further processing is performed. The system 102 displays the tentative CPDLC request in the CPDLC request window (depicted in window 200, window 300, and window 400). In the depicted example, dialogue box 202 indicates that a pushback/taxi has been requested for parking stand 605, and dialogue box 204 indicates that the day/time for the pushback/taxi request is 12/1244Z (the units of time being in the Zulu time zone in this example).

Upon receiving the tentative CPDLC request, the system 102 automatically and without further user input, uses received information from surrounding aircraft (provided by one or more traffic data sources 52), and conditions in the airport (relevant airport conditions information is provided by sources 106 of cockpit data 107) to predict whether the tentative CPDLC request will be accepted by the controller at ATC. The system dedicates an area 206 on the CPDLC request window 200 to displaying a predicted acceptance or a predicted rejection. In an embodiment, a sub-area 208 within the area 206 is dedicated to predicting an acceptance and a different sub-area 210 within the area 206 is dedicated to predicting a rejection. By providing a dedicated area on the CPDLC request window for these predictions, the pilot can quickly view and ascertain the prediction.

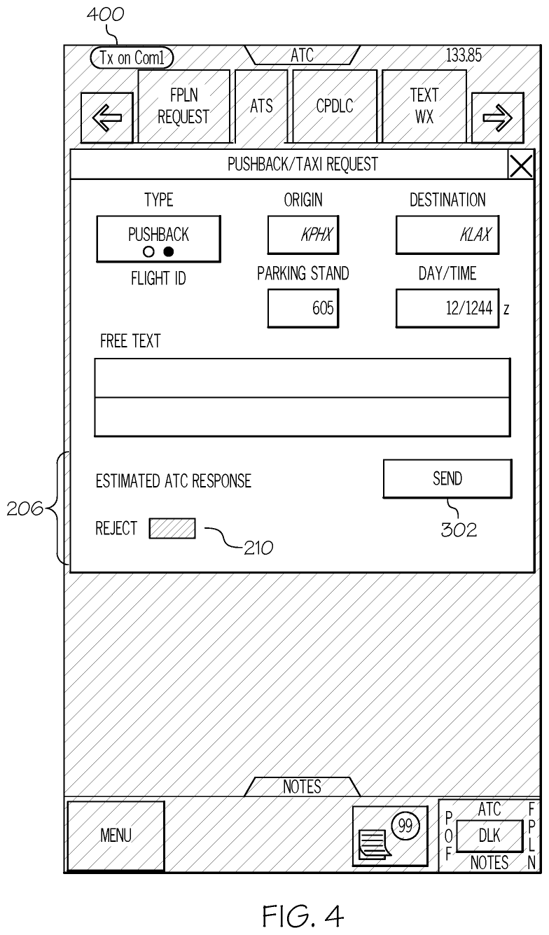

Further, various embodiments illuminate, or make visually distinguishable (with respect to the background), the sub-area that corresponds to the prediction. For example, in FIG. 3, the accept sub-area 208 may be rendered using a green color that is distinguishable against a different background color. In another example shown in FIG. 4, the reject sub-area 210 may be rendered using a yellow color that is distinguishable against a different background color, and distinguishable from a color used for accept. Upon viewing an accept prediction, a pilot may select a user selectable send button 302 that the system 102 has rendered in the CPDLC window, the selection of which converts the tentative CPDLC request to a CPDLC request and transmits the CPDLC request to ATC without further user input.

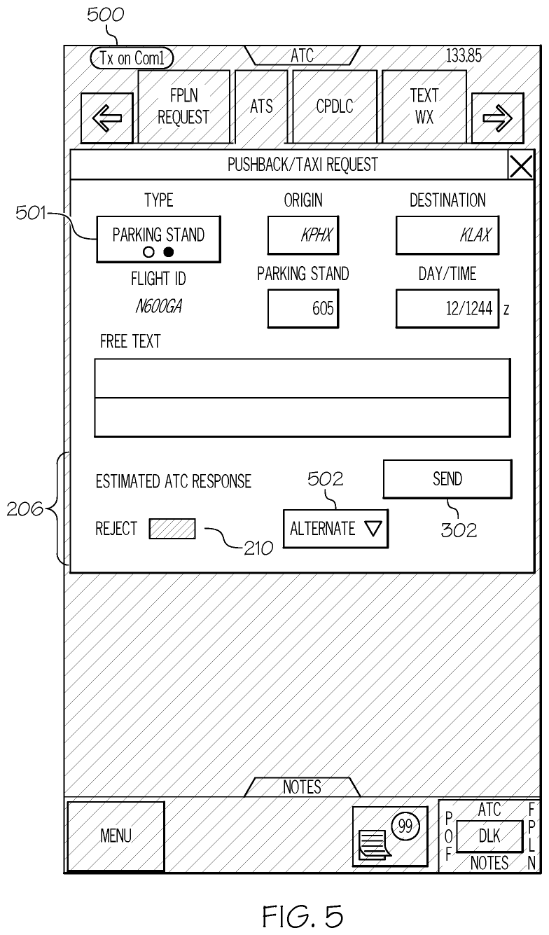

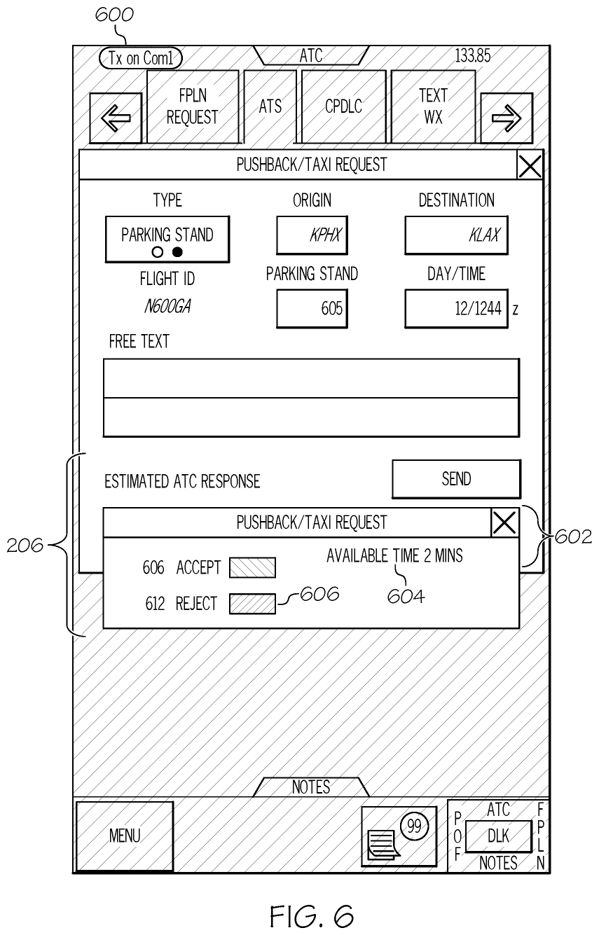

In FIGS. 5-6 a CPDLC parking stand request 501 is depicted. The pilot knows the size of his aircraft 100 and which stand is suitable for his aircraft 100, and the pilot makes an initial request (which is the tentative request, as before). In these examples, the tentative parking stand request for parking stand 605 is shown in the request window (depicted in window 500 and window 600). Dialogue box 202 indicates that parking stand 605 has been requested at Day/Time 12/1244Z. However, in this example, in area 206, a dialogue box is rendered, indicating a predicted rejection of the request in sub-area 210.

In various embodiments, responsive to predicting a rejection, the system 102 identifies one or more alternate requests that the pilot could make. In some embodiments, the system 102 renders a selectable dialogue box in the area 206 to indicate that potential alternate requests are available. When the pilot selects the alternate requests option 502, the one or more alternative requests is rendered on the window 600. In other embodiments, the one or more alternate requests are immediately rendered in the area 206, not requiring the user selection of an options button. In addition to providing this beneficial alternative request feature, the system can predict, for each of the one or more alternative requests, when the alternative request is available.

For each alternative request identified, the system 102 determines and displays an availability, which is an amount of time until the alternative request is predicted to be accepted; said differently, this is an amount of time the system 102 recommends pausing before sending the CPDLC request to air traffic control (ATC) to minimize a chance of a CPDLC rejection. As may be appreciated, the amount of time may be zero, meaning that there is no need to delay before transmitting the CPDLC request. In FIG. 6, an alternative parking stand 606 is depicted as predicted to be available in two minutes (“available time 2 mins” 604), and an alternative parking stand 612 is depicted as predicted to be rejected (606).

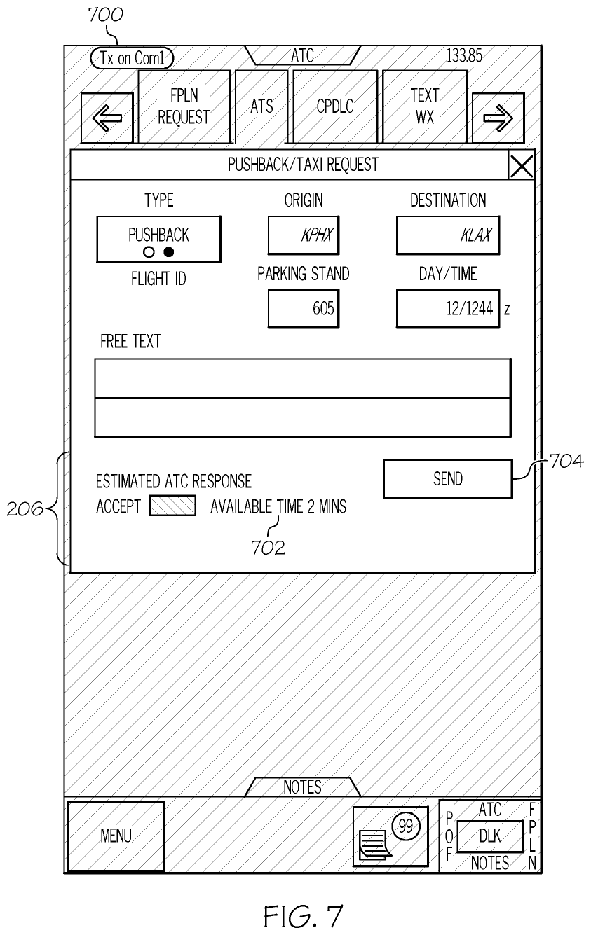

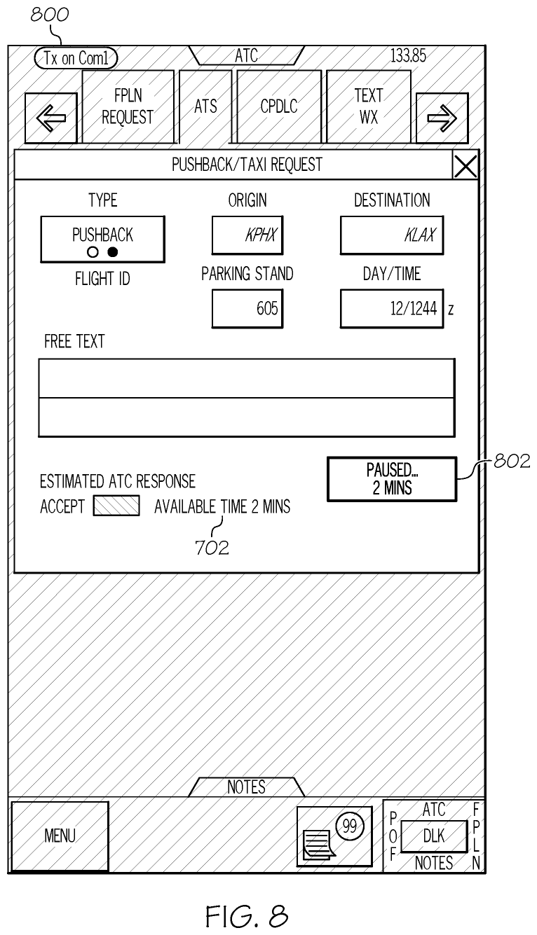

Moving now to FIGS. 7-8, a CPDLC pushback request from parking stand 605 is shown in window 700 and window 800. System 102 has predicted that ATC will accept the request in a first amount of time, defined as an amount of time to pause before sending the tentative CPDLC request to air traffic control (ATC). This is an amount of time the system 102 recommends pausing before sending the CPDLC request to air traffic control (ATC) to minimize a chance of a CPDLC rejection. The system 102 displays the first amount of time, which is two minutes (“available time 2 mins” 702) in FIG. 7.

Upon receiving a pilot selection of the send (704) button, the system 102 converts the tentative request into a CPDLC request. The system 102 is configured to provide an additional benefit of keeping track of the elapse of time, pausing the transmittal of the CPDLC request for the amount of time predicted (and displayed at 702), and sending the CPDLC request upon the elapse of the amount of time, without further user input. In various embodiments, the system 102 visually indicates a status of CPDLC transmission while an amount of delay time is counted down. For example, in FIG. 8, the send button 802 itself can be used as an indicator that the transmittal of the CPDLC request has been paused for the amount of time predicted. In various embodiments, the send button can be visually distinguished, can change color and/or a countdown could be displayed in area 206 to show the status of the CPDLC transmission while the predicted delay time is counted down. In other embodiments, a different indicator may be used to show that the transmittal of the CPDLC request has been paused for the amount of time predicted.

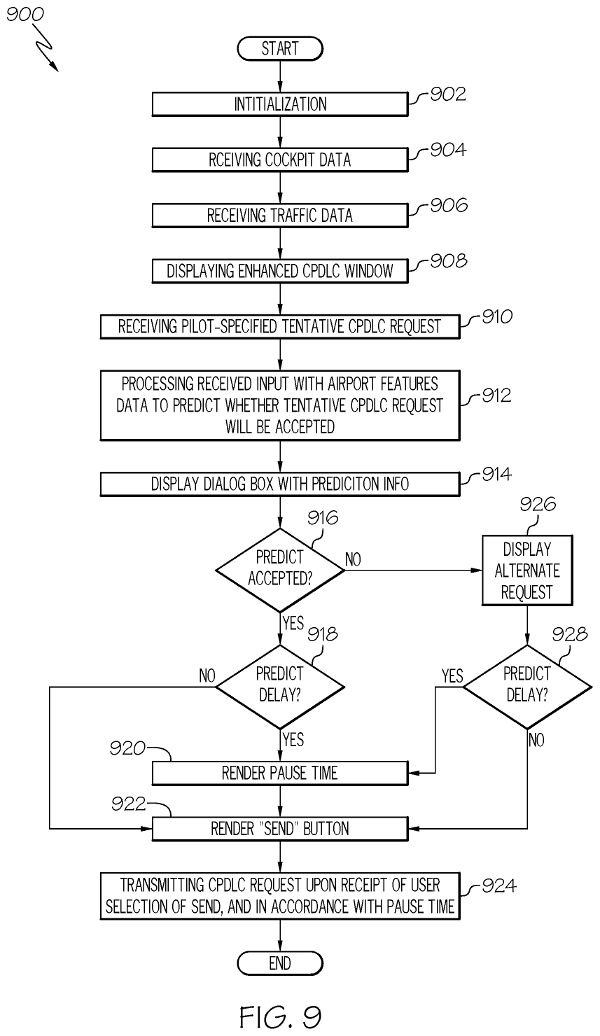

The system 102 described above may be implemented by a processor-executable method for reducing CPDLC rejection ratios 900, as shown in the flow chart of FIG. 9. For illustrative purposes, the following description of method 900 may refer to elements mentioned above in connection with FIG. 1. In practice, portions of method 900 may be performed by different components of the described system. It should be appreciated that method 900 may include any number of additional or alternative tasks, the tasks shown in FIG. 9 need not be performed in the illustrated order, and method 900 may be incorporated into a more comprehensive procedure or method having additional functionality not described in detail herein. Moreover, one or more of the tasks shown in FIG. 9 could be omitted from an embodiment of the method 900 as long as the intended overall functionality remains intact.

The method starts, and at 902 the controller 104 is initialized. As mentioned above, initialization may comprise uploading or updating instructions and applications 160 and CPDLC rejection reducing program 162.

At 904, cockpit data is received. As mentioned before, cockpit data is data from onboard sources such as the navigation system 118, FMS 119, and sensor system 122. Also, as mentioned, the sensor system 122 provides some data about the immediate external environment of the aircraft 100, which is distinguished from the sources of external data, such as the ATC 50 and traffic data source 52, which the aircraft receives data from at 906. At 908, the enhanced CPDLC request window is rendered on display system 116. At 910, a pilot-specified tentative CPDLC request is received. As previously mentioned, the pilot or crew may provide input via various user input devices, and directly on a touch screen display, when implemented. At 912, the received inputs are processed with airport features data and the system 102 predicts, based thereon, whether the controller at ATC 50 will accept or reject the tentative request; the prediction may have associated therewith, prediction information.

At 914, an area 206 is rendered on the enhanced CPDLC request window, and a display dialogue box with the prediction and prediction information is rendered therein. As described above, in connection with FIGS. 2-8, and further described in the following method steps, the prediction information can include a predicted acceptance, a predicted rejection, an alternative recommendation, and one or more predicted delays or pause times. If the prediction is an acceptance at 916, it is determined at 918 whether there is an associated predicted or recommended delay time. If there is a delay time, the associated delay or pause time is rendered at 920. A send button (or another similar graphical user interface widget to prompt the user to send/submit/select/etc.) is rendered at 922, and at 924, the CPDLC request is transmitted upon receiving or detecting a user selection of the tentative CPDLC request when it was predicted to be accepted, in accordance with the predicted delay time. Step 924 includes converting the tentative CPDLC request to a CPDLC request and transmitting the CPDLC request to ATC in accordance with the predicted delay time. In other words, if a delay was predicted at 918, the transmittal occurs after the elapse of the pause time, and if no delay is predicted at 918, the transmittal immediately occurs.

When the prediction is that the tentative CPDLC request will be rejected at 916, any available alternative requests may be indicated at 926. At 928, each alternative request is further evaluated as to whether there is a predicted delay time. When there is a predicted delay time, the method moves to 920 and when there is no predicted delay time, the method moves to 922. As mentioned, at 918 and at 928, the delay time may be zero; in which case, various embodiments of the system 102 do not display a zero.

Thus, the proposed system 102 for reducing controller-pilot data link (CPDLC) rejection ratio on an aircraft is a technologically improved CPDLC system that processes current conditions that ATC considers to predict a likelihood of acceptance of the CPDLC request. This beneficially averts sending CPDLC requests that are likely to be rejected and therefore reduces CPDLC rejection ratios overall. As is readily appreciated, the above examples of the system 102 are non-limiting, and many others may be addressed by the controller 104.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate the interchangeability of hardware and software, various illustrative components, blocks, modules, circuits, and steps have been described above generally in terms of their functionality. Whether such functionality is implemented as hardware or software depends upon the application and design constraints imposed on the overall system.

Skilled artisans may implement the described functionality in varying ways for each application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

Further, the various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of the method or algorithm described in connection with the embodiments disclosed herein may be embodied directly in hardware, in a software module executed by a controller or processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. When “or” is used herein, it is the logical or mathematical or, also called the “inclusive or.” Accordingly, A or B is true for the three cases: A is true, B is true, and, A and B are true. In some cases, the exclusive “or” is constructed with “and;” for example, “one from A and B” is true for the two cases: A is true, and B is true.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A processor implemented method for reducing controller-pilot data link (CPDLC) rejection ratio on an aircraft, comprising:
receiving, from a navigation system onboard the aircraft, navigation data for the aircraft;
receiving sensor data from a sensor system;
receiving traffic data from an external traffic data source;
displaying a CPDLC window on a display system;
receiving a tentative CPDLC request;
processing the navigation data, traffic data, and tentative CPDLC request with airport features data to predict whether the tentative CPDLC request will be accepted; and
displaying a dialogue box based upon the prediction,
wherein the displayed dialogue box indicates:
acceptance upon predicting that the tentative CPDLC request will be accepted; or
rejected and an alternative CPDLC request upon predicting that the tentative CPDLC request will not be accepted.

2. The method of claim 1, further comprising:
predicting that air traffic control (ATC) will accept the tentative CPDLC request in a first amount of time; and
displaying the first amount of time.

3. The method of claim 2, further comprising:
predicting that air traffic control (ATC) will accept the alternative CPDLC request in a second amount of time; and
displaying the second amount of time.

4. The method of claim 3, further comprising:
upon detecting a user selection of the tentative CPDLC request when it was predicted to be accepted, converting the tentative CPDLC request to a CPDLC request and transmitting the CPDLC request to ATC without further user input.

5. The method of claim 4, further comprising transmitting the CPDLC request after an elapse of the first amount of time.

6. The method of claim 5, further comprising visually distinguishing a send button to show a status of CPDLC transmission while the first amount of time is counted down.

7. The method of claim 4, further comprising:
upon detecting a user selection of the alternative request, converting the alternative CPDLC request to a CPDLC request and transmitting the CPDLC request to ATC without further user input.

8. The method of claim 7, further comprising transmitting the CPDLC request after an elapse of the second amount of time.

9. The method of claim 8, further comprising visually distinguishing a send button to show a status of CPDLC transmission while the second amount of time is counted down.

10. A system for reducing controller-pilot data link (CPDLC) rejection ratio on an aircraft, comprising:
a navigation system providing navigation data for the aircraft;
a sensor system onboard the aircraft; and
a processor operationally coupled to the navigation system and sensor system and configured to:
display a CPDLC window on a display system;
receive a tentative CPDLC request;
receive traffic data from an external traffic data source;
process the navigation data, traffic data, and tentative CPDLC request with airport features data to predict whether the tentative CPDLC request will be accepted by air traffic control (ATC), and that air traffic control (ATC) will accept the tentative CPDLC request in a first amount of time; and
upon predicting that the tentative CPDLC request will be accepted,
display a dialogue box indicating acceptance; and
display the first amount of time.

11. The system of claim 10, wherein the processor is further configured to:
upon detecting a user selection of the tentative CPDLC request when it was predicted to be accepted,
convert the tentative CPDLC request to a CPDLC request and transmitting the CPDLC request to ATC without further user input.

12. The system of claim 11, wherein the processor is further configured to transmit the CPDLC request after an elapse of the first amount of time.

13. The system of claim 12, wherein the processor is further configured to visually indicate a status of CPDLC transmission while the first amount of time is counted down.

14. The system of claim 10, wherein the processor is further configured to:
upon predicting that the tentative CPDLC request will not be accepted,
display a dialogue box indicating rejection and an alternative CPDLC request;
predict that air traffic control (ATC) will accept the alternative CPDLC request in a second amount of time; and
display the second amount of time.

15. The system of claim 14, wherein the processor is further configured to, upon detecting a user selection of the alternative request, convert the alternative CPDLC request to a CPDLC request and transmit the CPDLC request to ATC without further user input.

16. The system of claim 15, wherein the processor is further configured to transmit the CPDLC request after an elapse of the second amount of time.

17. The system of claim 16, wherein the processor is further configured to visually indicate a status of CPDLC transmission while the second amount of time is counted down.

18. An aircraft, comprising:
a navigation system providing navigation data for the aircraft;
a sensor system onboard the aircraft; and
a processor of a system for reducing controller-pilot data link (CPDLC) rejection ratio, the processor operationally coupled to the navigation system and sensor system and configured to:
display a CPDLC window on a display system;
receive a tentative CPDLC request;
receive traffic data from an external traffic data source;
process the navigation data, traffic data, and tentative CPDLC request with airport features data to predict whether the tentative CPDLC request will be accepted by air traffic control (ATC); and
display a dialogue box based upon the prediction,
wherein the displayed dialogue box indicates:
accepted and a first amount of time upon predicting that the tentative CPDLC request will be accepted by ATC in the first amount of time; or
rejected, an alternative CPDLC request, and a second amount of time upon predicting that the tentative CPDLC request will not be accepted, but the alternative CPDLC request will be accepted in the second amount of time.

19. The aircraft of claim 18, wherein the processor is further configured to:
upon detecting a user selection of the tentative CPDLC request when it was predicted to be accepted, convert the tentative CPDLC request to a CPDLC request and transmit the CPDLC request to ATC after an elapse of the first amount of time, without further user input.

20. The aircraft of claim 19, wherein the processor is further configured to:
upon detecting a user selection of the alternative request, convert the alternative CPDLC request to a CPDLC request and transmit the CPDLC request to ATC after an elapse of the second amount of time without further user input.
